(19) United States
(12) Patent Application Publication
(10) Pub. No.: US 2006/0164326 A1
(43) Pub. Date: Jul. 27, 2006

(54) Multi-display configuration method

(75) Inventor: Akira Date, Kunitachi (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/212,806

(22) Filed: Aug. 29, 2005

(30) Foreign Application Priority Data
Jan. 27, 2005 (JP) 2005-019041

(51) Int. Cl. G09G 5/00; G06F 15/16

(52) U.S. Cl. 345/1.3; 709/203

(57) ABSTRACT

A multi-display configuration method and a multi-display adaptor are disclosed, in which the digital content stream distributed through a network is displayed on a large screen configured of a plurality of displays, and the network, to which a plurality of the displays may be connected, is automatically set while automatically grasping the relative positions of the displays. In a system making up a screen by connecting displays having a network interface, the relative positions of the displays are extracted from the display connection. The relative positions of the displays and the network address mapping information of the displays are held. The digital content stream transmitted through the network is rebuilt into the data for the desired display, and the rebuilt data is coded by a variable length coder. The coded data is configured as a network packet and transmitted or received through the network interface.

### INCORPORATION BY REFERENCE

The present application claims priority from Japanese application JP2005-019041 filed on Jan. 27, 2005, the content of which is hereby incorporated by reference into this application.

### BACKGROUND OF THE INVENTION

1. Field of the Invention

This invention relates to a system for configuring a multi-display screen using a display to receive a digital content stream from a network, or in particular to a method of automatically executing the setting of a network from the connection of a plurality of displays and outputting the digital content stream to the plurality of the displays.

2. Description of the Related Art

The broadband system has been introduced to the internet more and more, and the internet bandwidth connected for ordinary home applications has been increased to such a degree that an increasing number of service providers now offer the several Mbit/s service. In this situation, the content distribution service through the internet has started, and the video transmission in the IP (internet protocol) network has added importance. The video information rate is vast as compared with the audio information, and the transmission of the video information requires the compression of the information rate, on which various researches have been conducted. As an example, the digital satellite broadcast using the communication satellite or the DVD employs the MPEG-2 (moving picture expert group-2) compression method. Depending on the image quality transmitted, the compression of about several hundred kbit/s to several tens of Mbit/s has been realized.

On the other hand, the ownership and use of a thin display of high image quality such as the PDP (plasma display panel) and the liquid crystal display have extended mainly among consumers. These thin displays of high image quality have the features of a small thickness, high image quality and a large screen, and in view of the fact that a lesser space is required and the image quality is higher than the conventional cathode-ray tube or projection TV, the thin display of high image quality is expected to be used more widely by stations, hospitals, department stores and public facilities.

With the extension of the network infrastructure, on the other hand, what is called the society of a ubiquitous network “usable by whoever, whenever and wherever” is considered to arrive. In the ubiquitous society, the displays are connected to the network and the content are expected to be distributed from a remote place through the network.

Also, in the ubiquitous network society, many terminals are considered to be connected to the network, and IPv6 is closely watched as one of the key techniques. Although IPv4 has widely extended, the movement to IPv6 is studied by IETF (Internet Engineering Task Force).

In the case where a large display is installed in a public facility or a place where a multiplicity of unspecified persons view the content, it has been the common practice to install a large display of stationary type. With the realization of the situation in which the display content can be received through a network, however, a large display is expected to come to have the portability. Specifically, a large display will come to be installed in a required place at a required time mainly to display the content. In view of the size limitation of a portable display for transportation, however, it is considered unrealistic to realize a screen of an ultra size (say, several hundred inches) with a single portable display. A plurality of portable displays of a realistically available size may be combined, therefore, to realize such an ultra size display.

Nevertheless, the digital content cannot be displayed on a plurality of displays according to the prior art. An analog video signal can be displayed on a plurality of displays by conversion at pixel level (up-sampling). The digital streaming data, however, are encoded for display on a single screen, and therefore the received content cannot be directly converted from a stream.

Even in the case where the received content are converted for display on a plurality of displays, the image is required to be rebuilt considering which pixel of a 1-frame image is displayed on which display. The content source, however, is not equipped with such information at all, and the packets for transmitting the content hold no information on the correspondence between the pixels and the displays. The digital content cannot be displayed on a plurality of displays, therefore, by the mere connection of a plurality of displays to a network and notification of the addresses of the plurality of the displays to the content source.

### SUMMARY OF THE INVENTION

Accordingly, it is an object of this invention to realize a means for displaying a digital content stream distributed through a network on a large screen configured of a plurality of displays, and also to provide a display having such a function.

In order to achieve this object, according to this invention, an image conversion adaptor called a “multi-display adaptor” having the function of rebuilding the digital streaming data is connected to a plurality of displays. In order to rebuild the digital streaming data, the multi-display adaptor according to the invention comprises a means for extracting the relative positions of the displays from the display connection and mapping the relative positions of a plurality of the displays and the network addresses of the displays, a means for extracting the macroblock address contained in the digital content stream, and a means for rebuilding the coding data of the macroblock as a data to the desired display based on the mapping information. The display data thus rebuilt is transferred to each display and displayed on each screen.

The multi-display adaptor may be fabricated as an independent product or in the form mounted on another product. For example, the multi-display adaptor may be incorporated in a set top box (STB) or a server, or a display proper. Also, the multi-display adaptor and a display may be connected to each other through a network or by a cable with an exclusive connection terminal.

According to this invention, the relative positions of displays connected by a network can be grasped automatically, and an image can be displayed on the desired display. Further, since the relative positions of the displays can be automatically grasped, a system can be constructed without being conscious of the display arrangement. Also, in view of the fact that the digital stream is partially decoded and divided/rebuilt as a data to the desired display, the multi-display can be realized without decoding to the pixel level.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a network configuration used in a multi-display adaptor according to a first embodiment.

FIG. 2 is a function block diagram showing a multi-display adaptor according to the first embodiment.

FIG. 3 is a flowchart for acquiring the display connection information.

FIG. 4 shows an example of a configuration of a mapping table according to the first embodiment.

FIG. 5 is a diagram showing the relation between the IP packet, MPEG-TS, PES (packetized elementary stream) and ES (elementary stream).

FIG. 6 is a diagram showing the relation between the coding units of MPEG.

FIG. 7 is a diagram showing the IP header structure of the message packet to notify the connection information to the multi-display adaptor from a display.

FIG. 8 is a diagram showing the payload structure of the message packet to notify the connection information to the multi-display adaptor from a display.

FIG. 9 is a diagram showing a hardware configuration of a multi-display adaptor according to a second embodiment.

FIG. 10 is a diagram showing the connection between the multi-display adaptor according to a third embodiment and a display.

FIG. 11 is a function block diagram showing a multi-display adaptor according to a fourth embodiment.

FIG. 12 shows an example of a configuration of the mapping table according to the fourth embodiment.

FIG. 13 shows a router solicit packet format.

FIG. 14 shows an option field format.

FIG. 15 shows a structure of the partial header of ES.

FIG. 16 is a function block diagram showing a multi-display adaptor according to the third embodiment.

FIGS. 17A and 17B are diagrams showing the relation between the stream division and the result of rebuilding.

### DETAILED DESCRIPTION OF THE INVENTION

### First Embodiment

A first embodiment in which one image data is reconfigured and displayed on four displays using a multi-display adaptor is explained below.

FIG. 1 is a diagram showing a content distribution system used with the multi-display adaptor according to this embodiment. Reference numeral 100 designates a content server to transmit various content including images and music as a streaming data to the network 101. The content data transmitted from the content server 100 are received by a multi-display adaptor 20 temporarily, and after being reconfigured, transmitted to the displays 103a to 103d as an IP packet. The display 103a, in addition to a screen unit having a display screen for displaying the content, includes a network connection unit 102a. The network connection unit 102a is configured of a network interface 104a, a memory 106a for storing the control software to control the transmission and receiving of packets, and a processor 105a for executing the software. The displays 103b to 103d also include a network connection unit of a similar configuration.

The displays 103b to 103d are connected to the display 103a through a network interface. The network interface 104a has a plurality of ports to connect a communication line such as a network cable, and the display according to this embodiment is assumed to have four input/output ports. The four signal input/output ports are each assigned an identifier. According to this embodiment, the four ports are assigned L, R, U and D as identifiers. The characters L, R, U, D indicate “left”, “right”, “up” and “down”, for example. The relative positions of the displays are determined based on the identifiers of the signal ports. The network connection unit 102a generates a message packet to notify a pair of information including the identifier of the port connected with other displays and the address corresponding to the particular port identifier, and transmits them to the multi-display adaptor 20. The multi-display adaptor 20 analyzes the relative positions of the displays based on the address information and the mutual connection information of the displays 103a to 103d, and acquires the connection information. The algorithm for analysis is described later.

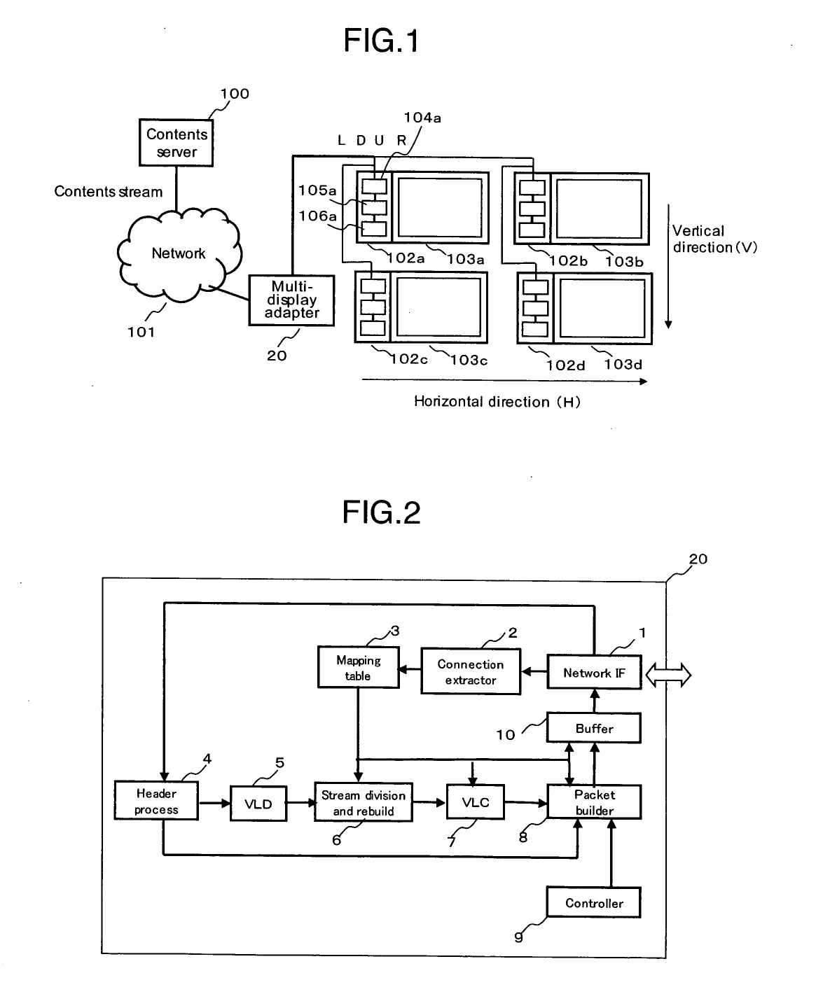

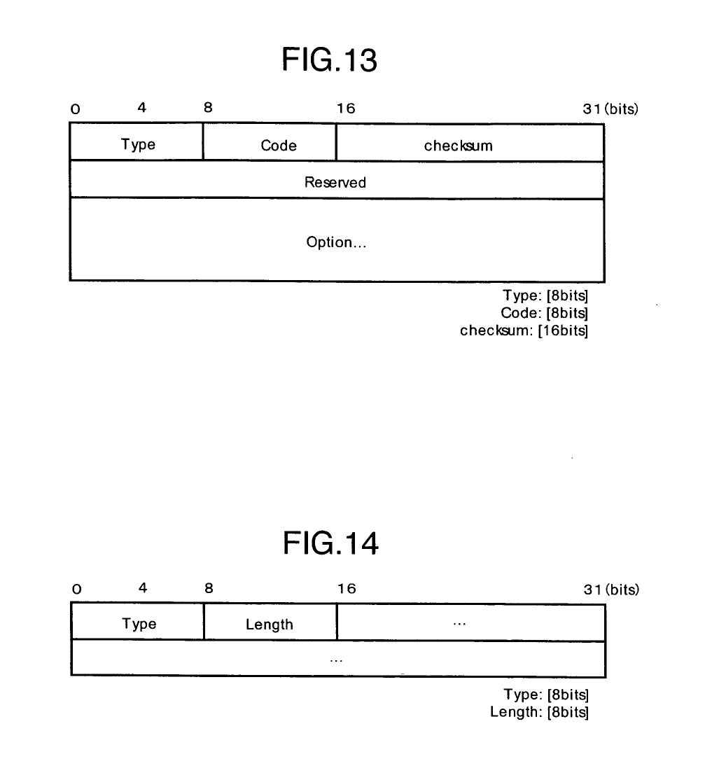

FIG. 2 shows a hardware configuration of the multi-display adaptor 20 according to this embodiment. The multi-display adaptor 20 according to this embodiment assumes that each component element is configured of an independent hardware, and each component element is configured of an ASIC, a semiconductor unit chip for a decoder, etc. In FIG. 2, numeral 1 designates a network interface (IF) providing a window to transmit or receive the packets to or from an external communication line. The network IF 1, upon receipt of a packet, analyzes the header information and determines whether the received packet is transmitted from the display 103a or distributed from the content server 100. In the case where the display 103a and the multi-display adaptor 20 are connected, for example, the operation is performed to set the network address in the network connection unit 102a. The network connection unit 102a issues a router solicitation message format packet (FIG. 13), and requests a network address. In the process, the MAC address and an identifier of the display of its own are described as an option. An option format is shown in FIG. 14. The multi-display adaptor 20 that has received this packet can acquire the knowledge that the terminal that has issued this packet is a display and the MAC address thereof. The packet from the content server is addressed to the multi-display adaptor 20, and therefore processed as it is.

In the case where the received packet is transmitted from the display 103a and constitutes a message packet to notify the relative positions of the displays, the received packet is transferred to the connection extractor 2. The connection extractor 2 determines the position information of each display and stores it in the mapping table 3.

In the case where the received packet is transmitted from the content server, on the other hand, the particular packet is transferred to the header processor 4 to execute the stream data reconfiguration process. This process is executed through a VLD unit 5, a stream division and rebuilder 6 and a VLC unit 7, so that the packet is finally divided for a plurality of displays while at the same time forming a coded streaming data. The image signal thus coded is transferred to the packet builder 8, assigned an IP header and rebuilt into an IP packet. The IP packet thus generated is stored temporarily in a buffer 10 and transmitted to an external communication line through the network IF 1.

The rebuilt packets may be output to the display from the network IF 1 simply on first-rebuilt first-out basis. Alternatively, however, the packets may be output taking the network leading to the multi-display adaptor 20 and the displays 102 into consideration. As an example, though described in detail later, the multi-display adaptor 20 and the number of hops to the displays 102 are related to each other in the mapping table 3, and the output to a display having a greater number of hops is given priority. In the process, the information relating a display to the number of hops is notified from the mapping table 3 to the buffer thereby to determine the order of output.

Also, the stream division/rebuilder 6 executes the process of dividing the input stream in accordance with the connected displays. In this case, the horizontal and vertical division information are processed based on the position information of the mapping table 3. The dividing process is explained in detail later. The VLD unit 7 is required to substitute the position information for each display, and the position information corresponding to each display is processed based on the position information of the mapping table 3 in the same manner as the division/rebuilding process. The processing method is explained later.

In the case where it is desired to display the input stream only on a specified display but not all the displays connected, only the packets addressed to the corresponding display are built and output. The position information of the display of which display is desired is input beforehand to the display controller 9 and notified to the packet builder 8. The packet builder 8 acquires the address of the display at the corresponding position from the mapping table 3 and thus builds only the corresponding packets.

Next, the operation of each component element shown in FIG. 2 is described in detail. Prior to the explanation of the operation of the position extractor 2, the process in which the multi-display adaptor 20 grasps the relative positions of the displays is explained.

As described above, the network connection unit of each display shown in FIG. 1 has the function of transmitting and receiving the packet. In FIG. 1, assume that each display is assigned an address. For simplification, assume that the address assigned to each display is an IP address. The IP address can be assigned by use of the router advertisement function of IPv6. In the case where IPv6 is used as a communication protocol, each display has the function of notifying the prefix of IPv6 thereof to the adjacent network device on the network (router advertisement function). In the absence of a response from the adjacent device, the network device that has transmitted the router advertisement determines that the particular prefix is not duplicated, and automatically generates the address of its own. This function is implemented by the processor executing the control software stored in the memory of the network connection unit. As a result, the IP address assignment to each display is realized. In the case under consideration, assume that the display 103a is assigned the address (2001: 240: 420: 1: 200: e2ff: fe92: 8eea), the display 103b the address (2001: 240: 420: 1: 200: e2ff: fe92: 8eeb), the display 103c the address (2001: 240: 420: 1: 200: e2ff: fe92: 8eec) and the display 103d the address (2001: 240: 420: 1: 200: e2ff: fe92: 8eed).

Next, each display notifies the IP address thereof to the displays connected to its signal port. As a result, each display acquires the IP addresses of the displays connected to the network connection unit. Once the IP addresses of the neighboring displays are made clear, the acquired IP addresses of the neighboring displays and the identifiers of the signal ports connected with the neighboring displays are notified to the multi-display adaptor. This process is explained in detail below.

In FIG. 1, the displays 103a to 103d each manage the upper, lower, left and right positions of the four signal ports by assigning the identifiers such as U, D, L, R. Once the IP addresses of the neighboring displays are acquired, the displays 103a to 103 each transmit the connection to the multi-display adaptor 20 as an option of the neighbor notification. In this case, the connection for the display 103a, for example, is given as (2001: 240: 420: 1: 200: e2ff: fe92: 8eea, R)-(2001: 240: 420: 1: 200: e2ff: fe92: 8eeb, L), (2001: 240: 420: 1: 200: e2ff: fe92: 8eea, D)-(2001: 240: 420: 1: 200: e2ff: fe92: 8eec, U). Specifically, this indicates that the right side (R) of the display 103a and the left side (L) of the display 103b are connected to each other and that the lower side (D) of the display 103a and the upper side (U) of the display 103c are connected to each other.

In similar fashion, the displays 103b, 103c, 103d notify the connection as a neighbor notification, and the multi-display adaptor 20 acquires the connection information of the displays.

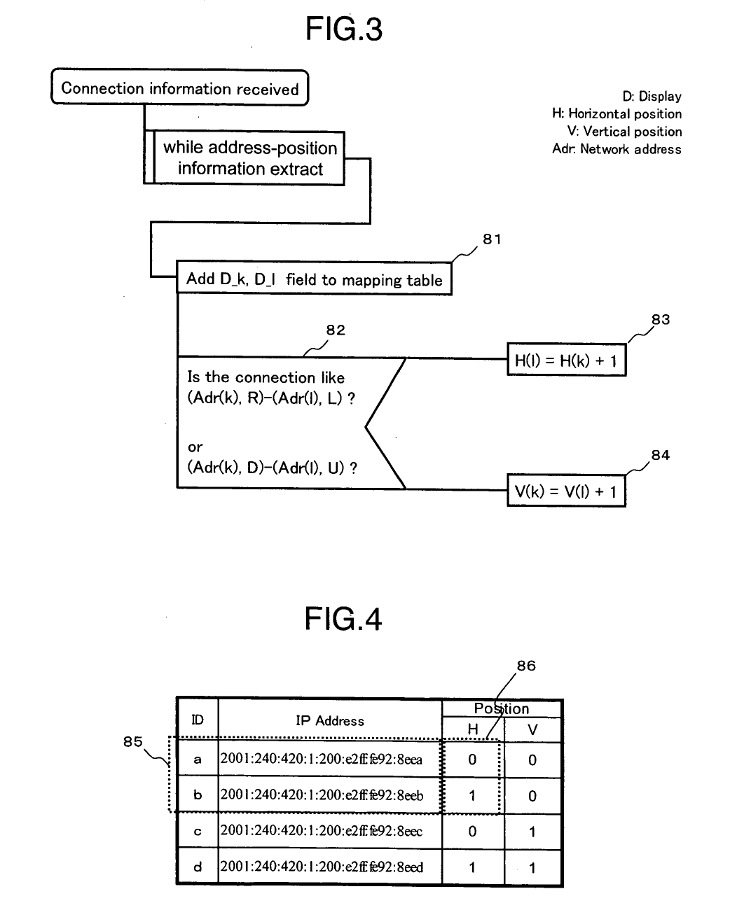

Next, with reference to FIG. 3, the process of connection analysis of each display executed by the connection extractor 2 is explained. From the connection of the displays 103a to 103d, or (2001: 240: 420: 1: 200: e2ff: fe92: 8eea, R)-(2001: 240: 420: 1: 200: e2ff: fe92: 8eeb, L), for example, “2001: 240: 420: 1: 200: e2ff: fe92: 8eea” and “2001: 240: 420: 1: 200: e2ff: fe92: 8eeb” described above are added as a field 85 to the mapping table 3 (step 81). Next, the relative positions are determined. With the network address Adr, whether two displays connected are right and left displays or or upper or lower displays is checked.

This information is checked (step 82), and in view of the fact that the right side of the display 103a and the left side of the display 103b are connected to each other, the relative positions are understood as horizontal, and therefore the relative positions in horizontal direction are determined (step 83). Specifically, H(b)=H(a)+1 is calculated and H(b)=1 is obtained, thus creating the field 86. In similar fashion, the vertical relation such as between the displays 21a, 21c is determined (step 84).

FIG. 4 shows an example of the configuration of the mapping table 3a. The mapping table 3a according to this embodiment includes such fields as an identifier field, an IP address field, a horizontal relative position field and a vertical relative position field. The mapping table is for relating the display position to the network address, and the identifier field indicates an identifier to identify the display connected to the network. The IP address field indicates the network address of the display designated by the identifier. The horizontal (H) relative position field indicates the horizontal position of the display designated by the identifier. The horizontal position is incremented one by one horizontally rightward from the origin (0, 0) set at the upper left corner, for example, on the display coordinate. Similarly, the vertical (V) relative position field indicates the vertical position of the display and incremented one by one vertically downward. The origin is not necessarily fixed at the upper left corner, but may be arbitrarily set at the lower left, lower right or upper right corner. Also, the coordinate may be incremented in the opposite direction horizontally or vertically.

Next, the process flow is explained for the case in which the received packet is found to be transmitted from the content server. The network IF 1, upon determination that the received packet is distributed from the content server, transfers the particular packet to the header processor 4. In the case where the network address is the multi-display adaptor 20 and the packet is addressed to the content distribution port, the data is the content data and output to the display through the following process. The header processor 4 processes the headers of TS and PES (Packetized Elementary Stream) contained in the received packet and acquires ES (Elementary Stream).

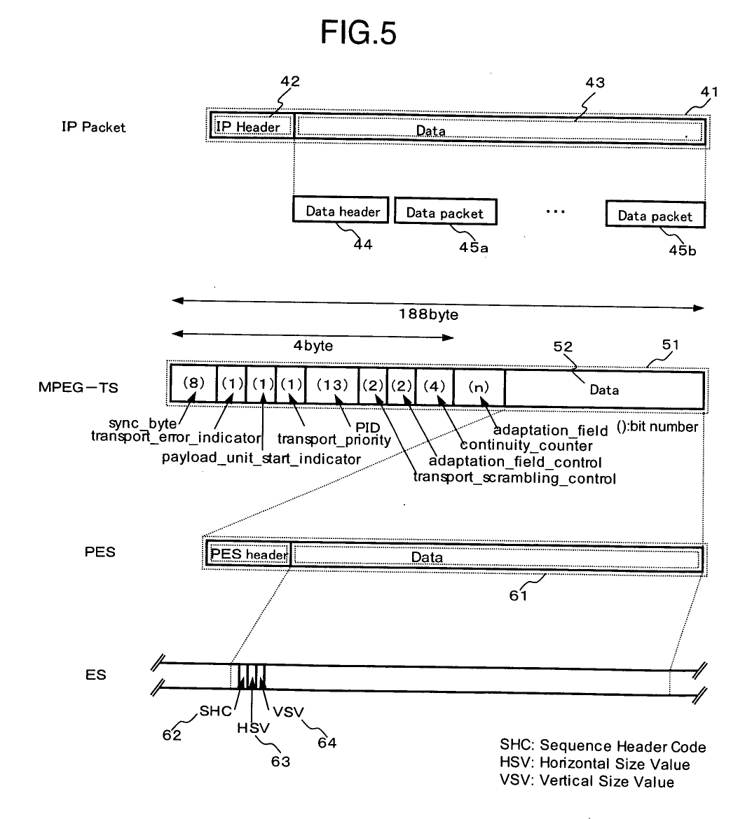

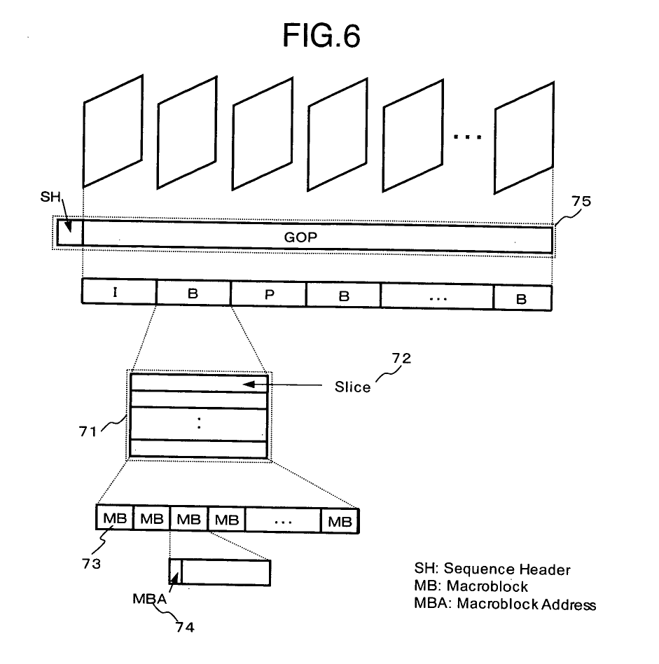

For reference, the relation between the packet and the stream is shown in FIGS. 5 and 6. The IP packet 41 includes an IP header field 42 and a data field 43. One of the methods of transmitting the content stream by the IP packets is to use UDP (User Datagram Protocol). The UDP packet, like the IP packet, includes a UDP header field 44 and a data field 45. The MPEG-TS packet 51 constituting the content stream is transmitted as the data of the UDP packet. The length of the MPEG-TS packet is fixed at 188 bytes. The MPEG-TS packet is configured of the TS packet header and the data 52. The PES packet 61 is transmitted in the data 52. The PES packet 61 is the ES constituting the data stream encoded from an image, divided by frame, and has a variable packet length. ES has a multiplexed sequence header including the information such as the number of pixels and the frame rate for each GOP (group of pictures). With the sequence header as a top, SHC 62 (sequence header code), HSV 63 (horizontal size value) and VSV 64 (vertical size value) are configured in that order.

FIG. 6 shows an outline of the ES coding unit. The unit in which the video frame 71 to be coded is divided into macroblocks described later in a way not to straddle the space between lines is called a slice 72. The slice is coded by being further divided into the unit of the macroblocks 73 of 16×16 pixels. The macroblocks are so configured that a macroblock escape code is followed by MBA (macroblock address) 74 indicating the current number of macroblocks plus one from the left end of the image. The slice number is associated with the vertical position, and MBA with the horizontal position of the image. Therefore, the position of a coded image is identified. By comparing this position with the information held in the mapping table 3, a particular display to which the stream is to be output can be determined.

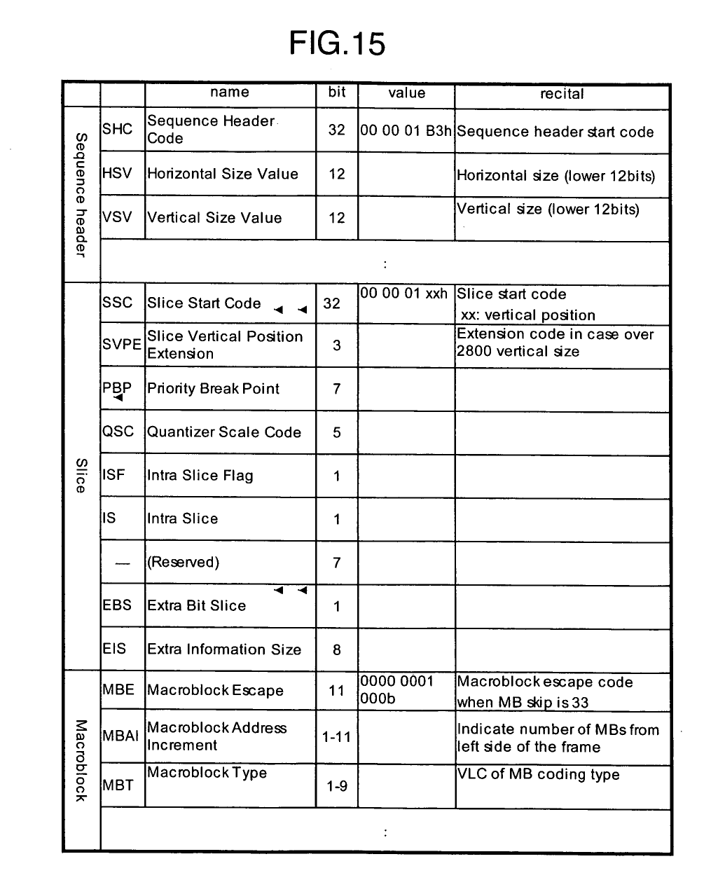

The ES data 75 thus obtained is transferred to the VLD (variable length decode) unit 5. The VLD unit 5 acquires the information including the number of horizontal pixels, the number of vertical pixels, the slice number and the macroblock address of the image from the ES data 75. The sequence header of the ES data 75 includes the starting code (32 bits) indicating the top of the sequence header followed by the HSV (12 bits) and VSV (12 bits) (FIG. 15). This is further followed by the information such as the aspect ratio of the screen. The number of horizontal pixels and the number of vertical pixels of the image can be acquired by reading the HSV and VSV. Similarly, the data on the slice 72 starts with the start code (32 bits) indicating the head of the slice. The last one byte of this start code indicates the vertical position of the slice. Therefore, the vertical position can be acquired by reading the last one byte (slice number) indicating the vertical position while retrieving the start code of the slice. The macroblock has no start code. The macroblock data, however, follows the slice data. The horizontal position is acquired by reading the MBAI (macroblock address increment) data.

Each information thus obtained is transferred to the stream division/rebuilder 6, and rebuilt for each display. The stream division/rebuilder 6 determines a particular display where the ES being processed should be displayed, based on the acquired information and the mapping information held in the mapping table 3. Also, the process is executed to convert the ES described above into the pixel information, the slice number and the macroblock address for the corresponding display. The number of screen divisions is determined from the mapping information of the mapping table 3. In the mapping table 3, the maximum value of the horizontal position plus 1 represents the number of divisions (assuming that the number of divisions in horizontal direction is m). In similar fashion, the number of divisions in vertical direction is the maximum value of the vertical position plus 1 (assuming that the number of divisions in vertical direction is n). From the number of pixels (HSV, VSV) and the number of divisions (m, n) of the screen acquired, the number of pixels H_new, V_new of the screen after division are determined as H_new=HSV/m, V_new=VSV/n, respectively.

With regard to the macroblock of which the macroblock address (MBA) before division exceeds H_new in pixel level, the position MBA_new (slice number) on the screen after division is MBA-Hnew/16, and MBA_new is substituted as a new MBA 74. In similar fashion, the vertical position (slice number) SLN_new after division is SLN-V_new/16. Also, the number of pixels of the sequence header of the stream after division is required to be substituted into H_new and V_new. The mapping table contains the description of the horizontal and vertical position information of the display connected, and the position information is used to determined the number of divisions and the position after division as described above.

The image signal rebuilt is transferred to and coded by the VLC (variable length code) unit 7. The streaming data thus coded is transferred to the packet builder 8, and converted to the IP packet. The IP packet finally generated is temporarily held in the buffer 10 to be output at the MPEG reference timing. After being thus held for a predetermined time, the IP packet is transmitted to an external communication line through the network interface 1.

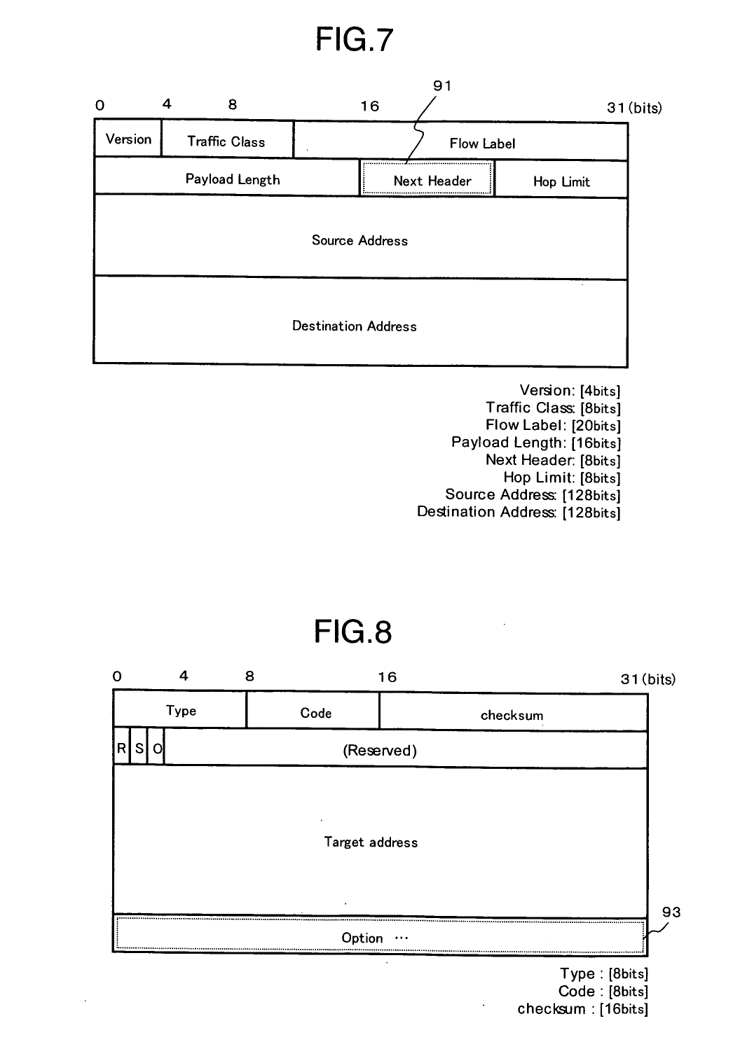

FIGS. 7, 8 show packet formats for notifying the neighboring display connection information between the displays or to the multi-display adaptor 20. FIG. 7 shows an example of the configuration of the IP header, and FIG. 8 an example of the configuration of the payload unit of the IP packet. The connection information is configured of the option 93 of the payload unit with the combined information of the address and the relative positions. Also, in the case of the IPv6 packet, the extension header can be added to the header, and the next extension header is indicated by the next header.

The foregoing explanation assumes that the display has an interface of the IP network. This invention is applicable to the network in general for distributing the packets with the network address as an identifier. In a local network, a configuration is available which uses the MAC address in the data link layer (Ethernet (registered trade mark), wireless LAN, etc.). The operation is similar to the case using the IP address, and in the mapping information shown in FIG. 3, the MAC address is held as information in place of the IP address. In this case, the position information notified from the display is a combination of the address and the position information.

As described above, this embodiment realizes a means for displaying a digital content stream on a large screen configured of a plurality of displays. The user of the large screen, i.e. the system builder is not required to be conscious of the connection of each display, thereby improving the user convenience conspicuously.

### Second Embodiment

The first embodiment concerns an example of realization of a multi-display adaptor as a hardware using various exclusive chips. The second embodiment, on the other hand, realizes the same function in software. The multi-display adaptor according to this embodiment is also assumed to be arranged in the same network as in FIG. 1.

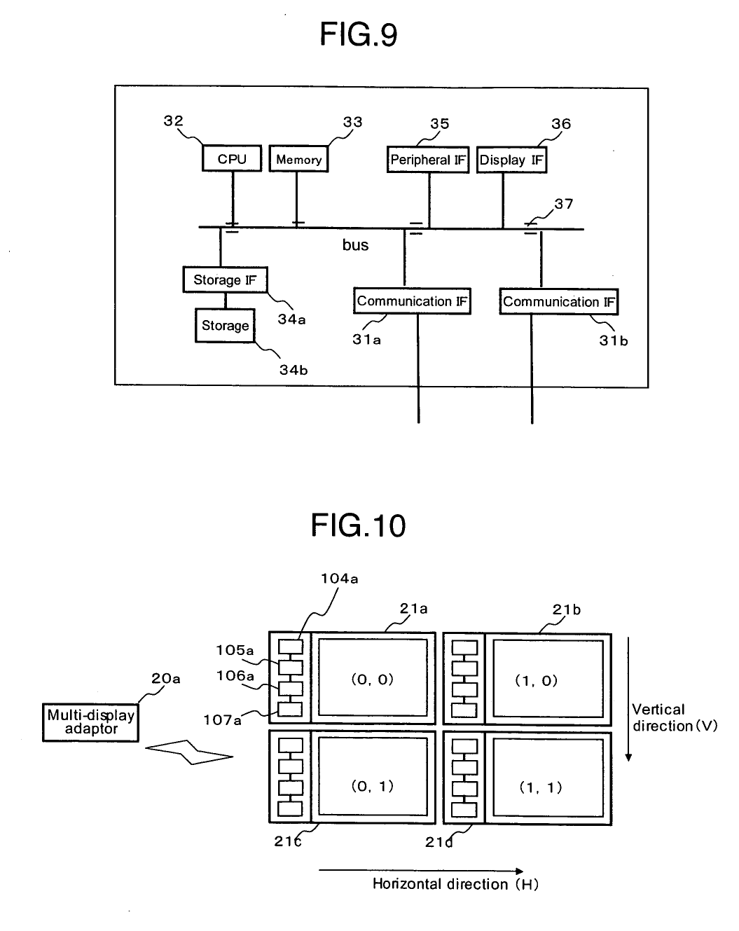

FIG. 9 shows a hardware configuration of the multi-display adaptor according to this embodiment. A communication interface 31 for conducting communication with the network, a CPU (Central Processing Unit) 32 for performing the arithmetic operation, a memory 33 for storing the internal data, etc., an interface for connecting an external storage unit 34 and the external storage unit 34, an interface 35 for connecting external input devices such as a mouse and a keyboard, and a display interface 36 for connecting a display device, etc. are interconnected through a bus 37. The content stream is input through the communication interface 31 and processed similarly to the first embodiment. The packets processed and rebuilt are transmitted to the desired display by the communication interface 31. The software for implementing each function shown in FIG. 2, stored in an external storage medium 34b and a memory 33, is read and executed by the CPU 32 as required.

### Third Embodiment

In the first and second embodiments, the network is connected by wire. The third embodiment, however, uses a radio network such as wireless LAN. The configuration of the multi-display adaptor according to this embodiment is similar to the configuration explained in the first or second embodiment. In the first and second embodiments, the connection can be determined from the physical position of the network port of the display. In the case where the network is configured of wireless LAN, however, the network connection is established in the range covered by the radio wave. Therefore, the connection between the displays is unknown, and the connection is required to be recognized by another means.

In FIG. 10, a switch 107a indicating the installed display position is added to indicate the horizontal and vertical positions. The switch 107 is an ordinary dip switch or a rotary switch set for horizontal and vertical positions.

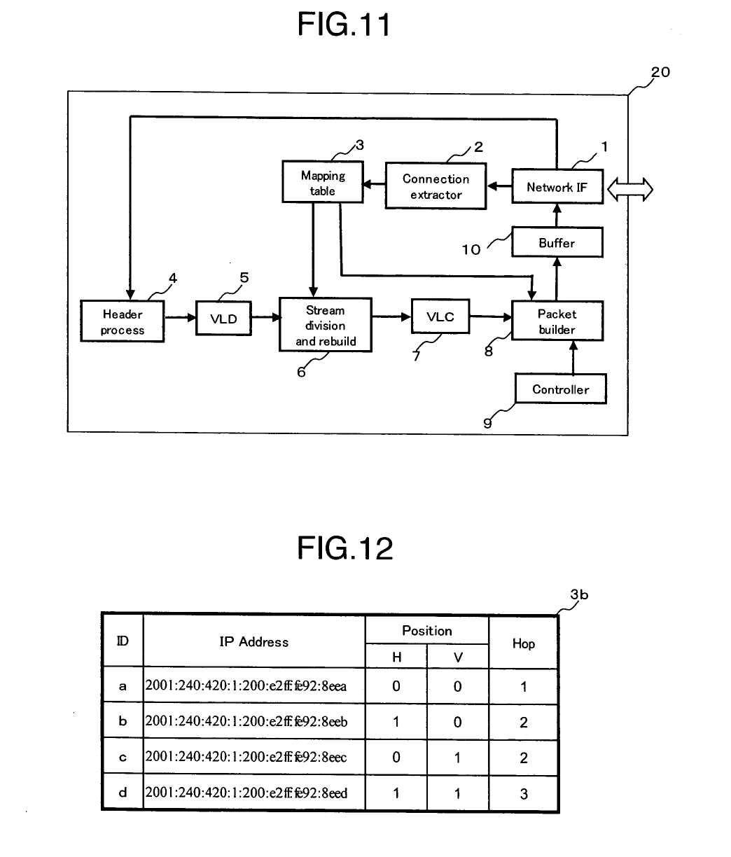

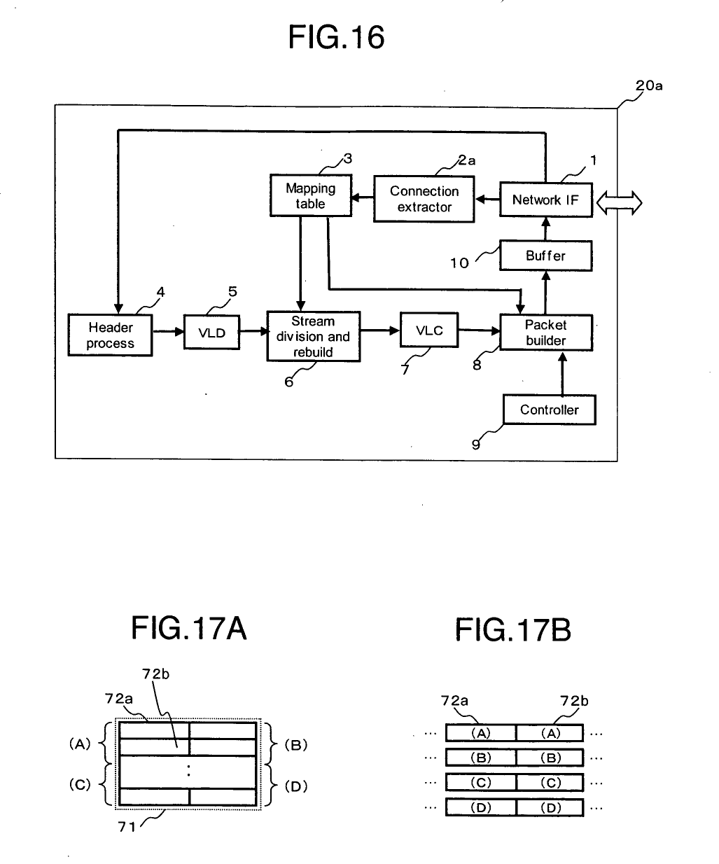

By notifying as an option of the neighbor notification message, the mapping information is built on the mapping table 3. A function block diagram of the multi-display adaptor according to this embodiment is shown in FIG. 16. The displays 21a to 21d communicate directly with the multi-display adaptor 20a. The display 21a is set to the position (0, 0) by the switch 107a, and therefore this information is notified directly to the multi-display adaptor 20a. Since the received information is the position information, on the other hand, the multi-display adaptor 20a, not requiring the connection extraction process shown in FIG. 3 by the connection extractor 2, reads the position information described in the packet option through the position information extractor 2a and stores the information in the mapping table 3. The other process is similar to that for the wire communication (FIG. 11). The switch indicating the position includes a pair of rotary switches or dip switches, horizontal and vertical, assigned the digits of 0 to 9 or the corresponding hexadecimal code.

Also in the case where a wire network instead of a wireless network is used, the positions of the displays are not necessarily automatically detected, but as in this embodiment, the displays may be configured as set by a switch or the like.

### Fourth Embodiment

This embodiment deals with an example the priority control of transmission of the rebuilt streaming data distribution packet. The priority control can be implemented with any of the system configurations according to the first and second embodiments, but an explanation is made with reference to FIG. 2 (first embodiment) for convenience sake.

In view of the need of displaying the same content in a plurality of display divisions, the streaming data or the content are required to be displayed in synchronism on each display. With the increase in the number of the displays connected to the multi-display adaptor 20, however, the time required for the rebuilt streaming data to reach each display is expected to lack the uniformity to an increasing degree. Although each display has a buffer memory to absorb the difference of the packet arrival time, the difference may not be absorbed by the buffer memory. In such a case, the image displayed on the display may be suspended or the content may or may not be displayed on different displays. In order to minimize this lack of uniformity, the multi-display adaptor according to this embodiment includes a priority control function corresponding to the number of hops between displays connected.

FIG. 11 shows an example of a configuration of the multi-display adaptor according to this embodiment. The operation of each component element is substantially the same as explained in FIG. 2, except that in this embodiment, unlike in the first embodiment, the information on the identifiers a to d and the number of hops corresponding to the identifiers are transmitted to the packet builder 8. In FIG. 2, the network address for configuring the network packet is notified to the packet builder 8 from the mapping table 3. The feature of this embodiment, however, is that the number of hops in addition to the network address is notified. The packet builder 8 determines the order in which the IP packets generated are buffered, based on the identifiers a to d and the number of hops, and transfers the result to the buffer memory 10. The buffer memory 10 transmits the packets from the network IF 1 in accordance with a predetermined transmission timing in accordance with the order in which the IP packets are stored in the buffer.

In the stream division/rebuilder 6 shown in FIG. 2, a particular screen after division is determined which corresponds to the position of MB 73 contained in the video frame 71 shown in FIG. 6, and the resulting stream classified is built into a stream for each display in the VLC unit 7 (FIG. 17B). The packet builder 8 builds a packet for transmitting, through the network, the stream constructed for each display. In the process, the network address indicated in the mapping table 3 is assigned to make up a packet. The packet has the same configuration as shown in FIG. 7.

The packet thus built is temporarily stored in the buffer 10 and output from the network interface IF 1. The packets output from the buffer 10 to the network IF 1 and destined to an address having a greater number of hops described on the mapping table 3 are given priority. The fact that priority is given by address, i.e. the packets destined to a display having a great number of hops are given priority, for example, is expected to minimize the variations of the packet time arrival at the display network interface 104 from the multi-display adaptor 20.

FIG. 12 shows a configuration of the mapping table 3b included in the multi-display adaptor according to this embodiment. Based on the connection notified from each display, the number of hops from the multi-display adaptor 20 to each display is determined. This information is held in the mapping table 3b, and based on the number of hops, the packets addressed to a display having a larger number of hops, i.e. a display distant in terms of network are output in priority. Specifically, the data are packetized in the memory 30 and sent to the communication interface 34 in the descending order of priority. Thus, the packets high in priority are output first.

The use of the multi-display adaptor according to this embodiment can reduce the probability of the image display being suspended on the display side even in the case where the number of displays connected is increased. The priority control function according to this embodiment is effective for wireless connection or especially in the low bandwidth the band is small between the multi-display adaptor and the displays.

It should be further understood by those skilled in the art that although the foregoing description has been made on embodiments of the invention, the invention is not limited thereto and various changes and modifications may be made without departing from the spirit of the invention and the scope of the appended claims.

1. A server connected to an image distribution server and a plurality of displays through a communication line, comprising:
a network interface;
a means for acquiring the relative position information and the network addresses of the plurality of the displays;
a means for dividing the image information received from the image distribution server based on the relative position information of the displays and rebuilding the image information corresponding to each of the plurality of the displays; and
a means for transmitting the rebuilt image information to the corresponding network address through the network interface.

2. A server connected to an image distribution server and a plurality of displays through a communication line, comprising:
a network interface;
an arithmetic operation means for executing a predetermined process on the packets received from the network interface; and
a storage means to store the software for causing the arithmetic operation means to execute the predetermined process;
wherein the arithmetic operation means executes the process comprising the steps of:
extracting the relative position information and the network addresses of the plurality of the displays from the received packet;
dividing the image information received from the image distribution server based on the relative position information of the displays and rebuilding the divided image information into the image information corresponding to each of the plurality of the displays; and
transmitting the rebuilt image information to a corresponding network address through the network interface.

3. The server according to claim 1,
wherein the relative position information is the information on the position of the network interface port of each of the displays.

4. The server according to claim 1, further comprising a mapping table for achieving the correspondence between the relative position information and the network addresses.

5. The server according to claim 4, wherein the mapping table includes:
an address field for storing the network address of each of the displays;
a vertical relative position information field for storing the vertical position information of the display; and
a horizontal relative position information field for storing the horizontal position information of the display.

6. The server according to claim 1,
wherein the network address is selected one of an IP address and a MAC address.

7. The server according to claim 6,
wherein the network address is acquired by the router advertisement transmitted by the display.

8. The server according to claim 5,
wherein the number of vertical divisions and the number of horizontal divisions of the image information are calculated from the relative position information.

9. The server according to claim 8,
wherein the image distribution server transmits the image information in the MPEG packet format, and
wherein the image data corresponding to each of the displays is rebuilt based on the slice number and the macroblock number contained in the received MPEG packet.

10. The server according to claim 1,
wherein the network interface is a wireless LAN port.

11. A set top box connected, through a communication line, to an image distribution server for transmitting the image information in MPEG packet format and a plurality of displays for displaying the image information transmitted from the image distribution server, comprising;
a LAN port;
a processor for processing the packets received from the LAN port; and
a storage means for storing the software for causing the processor to execute the process;
wherein the arithmetic operation means executes the steps of:
extracting the relative position information and the network addresses of the plurality of the displays from the received packet;
dividing the image data contained in the MPEG packet received from the image distribution server based on the relative position information and rebuilding the image data into the image information corresponding to each of the plurality of the displays; and
transmitting the rebuilt image information to the corresponding displays through the network interface.

12. The server according to claim 2,
wherein the image distribution server transmits the image information in the MPEG packet format, and
wherein the image data corresponding to each of the displays is rebuilt based on the slice number and the macroblock number contained in the received MPEG packet.

13. The server according to claim 2,
wherein the relative position information is the information on the position of the network interface port of each of the displays.

14. The server according to claim 2, further comprising a mapping table for achieving the correspondence between the relative position information and the network addresses.

15. The server according to claim 2,
wherein the network address is selected one of an IP address and a MAC address.

16. The server according to claim 2,
wherein the network interface is a wireless LAN port.
